(19) United States
(12) Patent Application Publication
(10) Pub. No.: US 2026/0310418 A1
(43) Pub. Date: Oct. 8, 2026

(54) ZERO-FREE SELF-CONTAINED COMPUTING SYSTEM

(71) Applicants: Bo Payne, College Grove, TN (US); Nathan Reeve, Cypress, TX (US)

(72) Inventors: Bo Payne, College Grove, TN (US); Nathan Reeve, Cypress, TX (US)

(21) Appl. No.: 19/347,394

(22) Filed: Oct. 1, 2025

Related U.S. Application Data
(63) Continuation of application No. 19/172,780, filed on Apr. 8, 2025.

(51) Int. Cl. G06F 9/445

(52) U.S. Cl. CPC G06F 7/727; G06F 7/49905; G06F 7/49926

(57) ABSTRACT

A zero-free self-contained computing system performs numerical operations within a bounded, non-singular modular domain to eliminate undefined states, floating-point drift, and modular arithmetic failures. The system includes a processing core with a modular arithmetic unit, fractal digital-root encoder, and oscillatory number-system controller; a memory architecture using zero-free cache encoding and self-correcting address mapping; and a logic controller that executes zero-free arithmetic instructions through a unified integer and floating-point framework. The architecture supports hardware, software, and distributed implementations, enabling stable neural-network computation, cryptographic processing, and error-free multi-node consensus through cyclic arithmetic, recursive scaling, and digital-root correction.

### CROSS-REFERENCE TO RELATED APPLICATIONS

This application claims the benefit of U.S. Nonprovisional Application Ser. No. 19/172,780 filed on Apr. 8, 2025, which is hereby incorporated in its entirety.

### FIELD OF THE INVENTION

The present invention is directed to a zero-free self-contained computing system (ZSCS) that is a computational framework that allows for compact, efficient implementations. More specifically, ZSCS comprises a computational engine that eliminates undefined operations, floating-point drift, and modular arithmetic failures. ZSCS is capable of being operated in hardware, software, and distributed computing environments, offering universal numerical stability. Furthermore, ZSCS is an efficient computational framework that uses a “zero as n” in arithmetic computations while maintaining flexibility and modularity.

### BACKGROUND OF THE INVENTION

Some of the pitfalls of conventional modular arithmetic include precision degradation, exception handling, and system limitations. Common problems with using conventional arithmetic include operations like undefined states, division by zero, modular overflow, and floating-point rounding errors which create undefined or inconsistent states. In addition, traditional modulo arithmetic requires periodic resets and can lead to a loss of information.

Conventional systems rely on complex error handling, floating-point workarounds, and modular resets, leading to bloated codebases. These traditional models can require thousands of lines of code.

Traditional modular libraries often include extensive exception handling for undefined operations, redundant precision correction mechanisms, and multiple functions for different number types (e.g., integers, floats, modular forms).

Therefore, there exists a need for a computational engine that eliminates undefined operations, rounding errors, overflow errors, and modular arithmetic limitations.

### SUMMARY OF THE INVENTION

The present invention is directed to a zero-free self-contained computing system that is a computational framework that allows for compact, efficient implementations. ore specifically, ZSCS comprises a computational engine that eliminates undefined operations, floating-point drift, and modular arithmetic failures. ZSCS is capable of being operated in hardware, software, and distributed computing environments, offering universal numerical stability. Furthermore, ZSCS is an efficient computational framework that uses a “zero as n” in arithmetic computations while maintaining flexibility and modularity.

In an exemplary embodiment, the zero-free self-contained computing system for use in computer hardware, software, and distributed computing comprises a processing core, wherein the processing core comprises a modular arithmetic unit, a fractal digital root encoder, and an oscillatory number system controller; a memory architecture, wherein the memory architecture comprises a zero-free cache encoding structure and a self-correcting address mapping structure; and a logic controller, wherein the logic controller comprises a zero-free instruction processing unit and a unified integer and floating-point framework.

In one embodiment, the zero-free self-contained computing system is designed using Verilog or VHSIC Hardware Description Language through Field Programmable Gate Arrays (FPGA) implementation.

In another embodiment, the zero-free self-contained computing system comprises a mod 9 processing structure. In yet another embodiment, the zero-free self-contained computing system comprises a mod 1296 processing structure.

In yet another embodiment, the zero-free self-contained computing system is capable of being implemented in software and further comprises a plurality of ZSCS libraries, a plurality of ZSCS virtual machines, a ZSCS AI integration module, and a cryptographic security module.

In an alternate embodiment, the plurality of ZSCS libraries are capable of being implemented in software as a self-contained computational framework, replacing conventional number systems and arithmetic logic.

In one embodiment, the plurality of ZSCS virtual machines comprises a software-emulated environment. In another embodiment, the ZSCS AI integration module is capable of allowing more stable neural network calculations.

In another embodiment, the cryptographic security module is capable of preventing side-channel attacks caused by floating-point imprecisions and timing vulnerabilities.

In an embodiment, the software is implemented using Python.

In an exemplary embodiment, the software comprises the following steps: (1) starting the program, (2) inputting a number, (3) performing SCG operation (addition/multiplication), (4) applying modular correction (dr(n) formulation), (5) outputting a valid result, and (6) ending the program.

In an embodiment, the zero-free self-contained computing system further comprises a universal inverse mechanism.

In one embodiment, the zero-free self-contained computing system is capable of being implemented in distributed computing and further comprises a ZSCS distributed node 1, a ZSCS distributed node 2, and a ZSCS distributed node 3.

In another embodiment, the zero-free self-contained computing system comprises the following steps: (1) comparing modular operations in the ZSCS distributed node 1, (2) passing result in the ZSCS distributed node 1, (3) validating modular correctness in the ZSCS distributed node 2, (4) storing calculations in immutable ledger in the ZSCS distributed node 2, and (5) achieving consensus with zero data loss in the ZSCS distributed node 3.

In another embodiment, the zero-free self-contained computing system further comprises ZSCS-based hashing using digital root stabilization.

In one embodiment, the zero-free self-contained computing system further comprises ZSCS smart contracts used to eliminate rounding errors that cause financial transaction inconsistencies.

In yet another embodiment, the modular arithmetic unit comprises the following steps: (1) receiving an input from the set {1-9}, (2) processing the input through modular cyclic operations, and (3) producing an output, wherein the output is a valid numerical result.

In one embodiment, the software comprises the following steps: (1) receiving an input, (2) processing input through a modular board, (3) ZSCS function calling, and (4) producing an output.

In yet another embodiment, the zero-free self-contained computing system further comprises a TCTArithmetic engine. In an embodiment, the TCTArithmetic engine comprises the following steps: (1) initializing TCT arithmetic with a given modulus, (2) raising ValueError when division by zero is undefined in TCT, and (3) checking if number is prime within the TCT system.

In one embodiment, the zero-free self-contained computing system further comprises a SCGArithmetic engine, wherein the SCGArithmetic engine comprises a library of various “zero equals n” arithmetic functions.

Various objects, features, aspects, and advantages of the inventive subject matter will become more apparent from the following detailed description of exemplary embodiments, along with the accompanying figures in which like numerals represent like components.

### BRIEF DESCRIPTION OF DRAWINGS

FIG. 1 depicts a block diagram of an exemplary embodiment of the zero-free self-contained computing system used in computer hardware.

FIG. 2 depicts a block diagram of an alternate embodiment of the zero-free self-contained computing system used in computer software.

FIG. 3 depicts a sample of the software program code used in an exemplary embodiment of zero-free self-contained computing system.

FIG. 4 depicts a block diagram of an exemplary embodiment of the zero-free self-contained computing system used in distributed computing.

FIG. 5 depicts a block diagram of an exemplary embodiment of the arithmetic logic unit.

FIG. 6 depicts a flow chart of an exemplary embodiment of the software being used in the zero-free self-contained computing system.

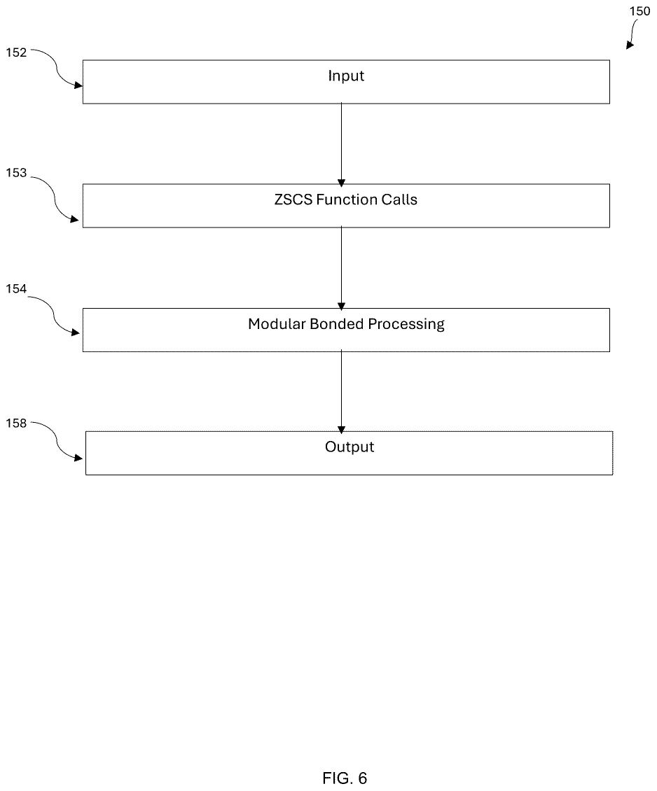

FIG. 7 depicts a flow chart of an exemplary embodiment of the distributed computing in the zero-free self-contained computing system.

FIG. 8 depicts a sample of the software code used in the TCTArithmetic engine.

FIG. 9 depicts a sample of the software code used in the TCTArithmetic engine.

FIG. 10 depicts a sample of the software code used in the SCGAritmetic engine.

FIG. 11 depicts a sample of the software code used in validating an exemplary embodiment of a zero-free self-contained computing system.

FIG. 12 depicts a sample of the software code used in validating an exemplary embodiment of a zero-free self-contained computing system.

FIG. 13 depicts a sample of the software code used in validating an exemplary embodiment of a zero-free self-contained computing system.

FIG. 14 depicts a test script for testing floating-point drift elimination used in validating an exemplary embodiment of a zero-free self-contained computing system.

FIG. 15 depicts a test script for testing zero-free modular arithmetic consistency used in validating an exemplary embodiment of a zero-free self-contained computing system.

FIG. 16 depicts a test script for testing recursive scaling consistency used in validating an exemplary embodiment of a zero-free self-contained computing system.

FIG. 17 depicts a test script for testing error accumulation in a neural network used in validating an exemplary embodiment of a zero-free self-contained computing system.

FIG. 18 depicts a test script for testing cryptographic factorization efficiency used in validating an exemplary embodiment of a zero-free self-contained computing system.

FIG. 19 depicts a test script for testing distributed computing precision used in validating an exemplary embodiment of a zero-free self-contained computing system.

### DETAILED DESCRIPTION OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term is an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute value of the numeral to 10% above the absolute value of the numeral, inclusive.

As used herein, the terms “zero-free self-contained computing system”, “ZSCS”, and “SCG” are used interchangeably throughout the disclosure.

As used herein, the terms “step” and “instruction” are used interchangeably throughout this disclosure.

The present invention is directed to a zero-free self-contained computing system that is a computational framework that allows for compact, efficient implementations. More specifically, ZSCS comprises a computational engine that eliminates undefined operations, floating-point drift, and modular arithmetic failures. ZSCS is capable of being operated in hardware, software, and distributed computing environments, offering universal numerical stability. Furthermore, ZSCS is an efficient computational framework that uses a “zero as n” in arithmetic computations while maintaining flexibility and modularity.

The zero-free self-contained computing system creates a closed, self-correcting modular framework preventing divide-by-zero errors and replacing zero with a cyclical modulus (n) ensuring all operations produce defined, bounded results. Treating zero as “n” ensures the domain is bounded and cyclic rather than unbounded and singular.

ZSCS uses a self-contained modular approach where computations cycle through a predefined, non-singular number space. Using this modular, oscillatory number system allows for continuous numerical integrity, including recursive and exponential operations.

ZSCS uses recursive scaling, allowing computations to expand infinitely without overflow. This is accomplished by layered scaling, fractal arithmetic, and oscillatory computation. In layered scaling, computations scale dynamically through predefined factors ensuring stability. In fractal arithmetic, ZSCS enables deep numerical recursion without loss of precision. In oscillatory computation, numbers cycle within bounded domains, preventing runaway errors.

The following is an example of recursive scaling modeling, wherein a value can transition across different layers of computation: (1) Layer 1 comprises integer-based modular operations, (2) Layer 2 comprises fractal-based multiplications, (3) Layer 3 comprises high-dimensional recursive transformations, (4) Layer 4+ comprises quantum or AI-driven computational extensions.

ZSCS allows for multiple computational engines that operate independently but remain consistent within the ZSCS framework. The Cyc9 Engine comprises a zero-free modular engine wherein 9 acts as the stabilizing factor. The Beta Scaling Engine extends ZSCS to recursive, fractal-based computations. The CMTS Quant Engine applies layered modular scaling to optimize for AI and cryptographic applications. The Base Plus Engine comprises a universal engine that adapts ZSCS to different computational architectures. Each of the engines applies ZSCS principles uniquely to various computational tasks.

ZSCS can be implemented in hardware, software, and distributed systems. Under hardware implementation, ZSCS can be embedded into processors using ZSCS arithmetic logic units for high-efficiency computations, memory compression & lossless storage for ZSCS-based memory mapping reducing overhead and maximizing precision, and quantum computing integration eliminating probabilistic computation errors and making quantum gates more stable. Additionally, ZSCS can be implemented in custom computational circuits, FPGAs (Field Programmable Gate Arrays), ASICS (Application-Specific Integrated Circuits), and quantum computing architectures.

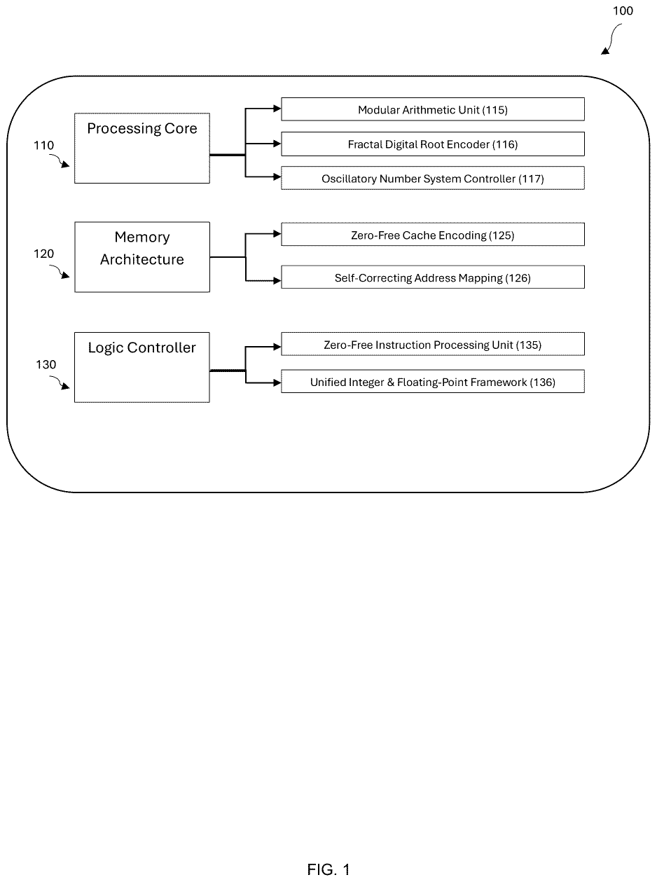

FIG. 1 depicts a block diagram of an exemplary embodiment of zero-free self-contained computing system 100 used in computer hardware, wherein ZSCS comprises processing core 110, memory architecture 120, and logic controller 130. In this embodiment, processing core 110 comprises modular arithmetic unit 115, fractal digital root encoder 116, and oscillatory number system controller 117; memory architecture 120 comprises zero-free cache encoding 125 and self-correcting address mapping 126; and logic controller 130 comprises zero-free instruction processing unit 135 and unified integer & floating-point framework 136.

In one embodiment, the oscillatory number system controller comprises logic circuitry configured to regulate transitions between representational states using the oscillatory modular update cycle described herein. The controller maintains numerical values within a bounded, non-singular domain by applying cyclic transformations that prevent drift, overflow, or undefined states. The oscillatory update cycle ensures that each arithmetic operation remains consistent with the zero-free modular framework.

In one embodiment, the zero-free instruction processing unit comprises decoding logic configured to interpret zero-free opcodes and execution logic configured to process operands represented using the zero-free digit set {1-9}. The decoding logic translates incoming instructions into bounded arithmetic operations, and the execution logic applies the zero-free modular rules to ensure that all results remain within the defined representational domain.

In one embodiment, the zero-free cache encoding structure comprises memory-mapping logic configured to store values using the zero-free positional representation described herein. The memory-mapping logic encodes each stored value using a non-zero modular representation, preventing the creation of undefined or zero-state entries within the cache hierarchy.

In one embodiment, the self-correcting address mapping structure comprises address-translation logic configured to detect representational inconsistencies and remap addresses using the correction rule described herein. The address-translation logic monitors memory accesses for invalid or out-of-range states and applies modular correction to maintain a consistent, zero-free addressing domain.

In an embodiment, zero-free self-contained computing system 100 is capable of being designed using Verilog or VHSIC Hardware Description Language (VHDL) through Field Programmable Gate Arrays (FPGA) implementation. In this embodiment, zero-free self-contained computing system 100 comprises a mod 9 or mod 1296 processing structure.

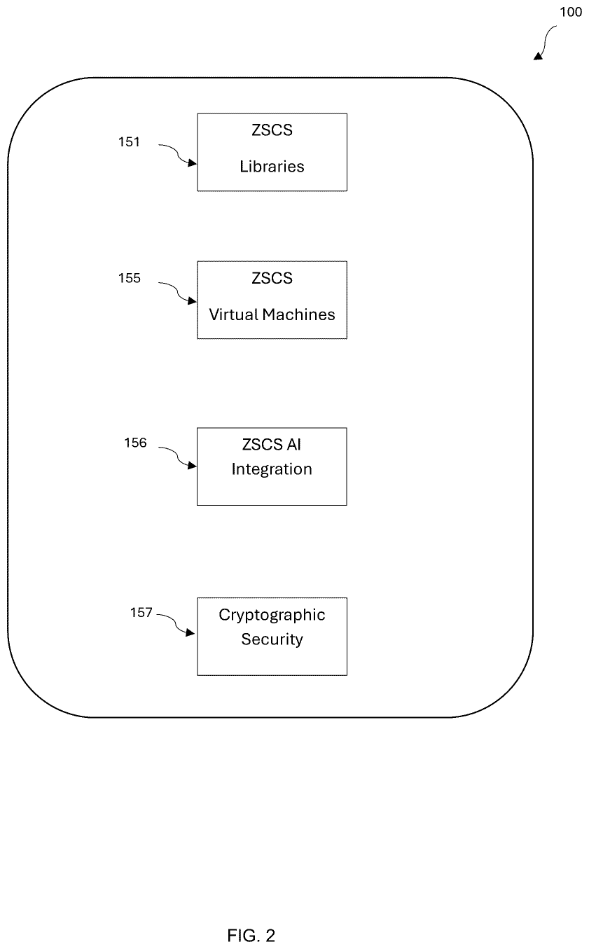

In an alternate embodiment, zero-free self-contained computing system 100 comprises ZSCS libraries 151, ZSCS virtual machines 155, ZSCS AI integration 156, and cryptographic security 157 and is capable of being implemented in software as a self-contained computational framework, replacing conventional number systems and arithmetic logic. In this embodiment, ZSCS libraries 151 and APIs are capable of replacing traditional math libraries with ZSCS-based operations. In ZSCS libraries 151, functions replace standard math operations with bounded, cyclic equivalents preventing floating-point drift or division errors (see FIG. 2).

ZSCS virtual machines 155 comprises a software-emulated environment allowing existing codebases to transition to ZSCS 100 without modifying low-level system instructions. ZSCS virtual machines 155 create a zero-free execution environment for modern applications. ZSCS AI Integration 156 allows for more stable neural network calculations, preventing catastrophic accumulation errors in machine learning models.

Cryptographic Security 157 prevents side-channel attacks caused by floating-point imprecisions and timing vulnerabilities.

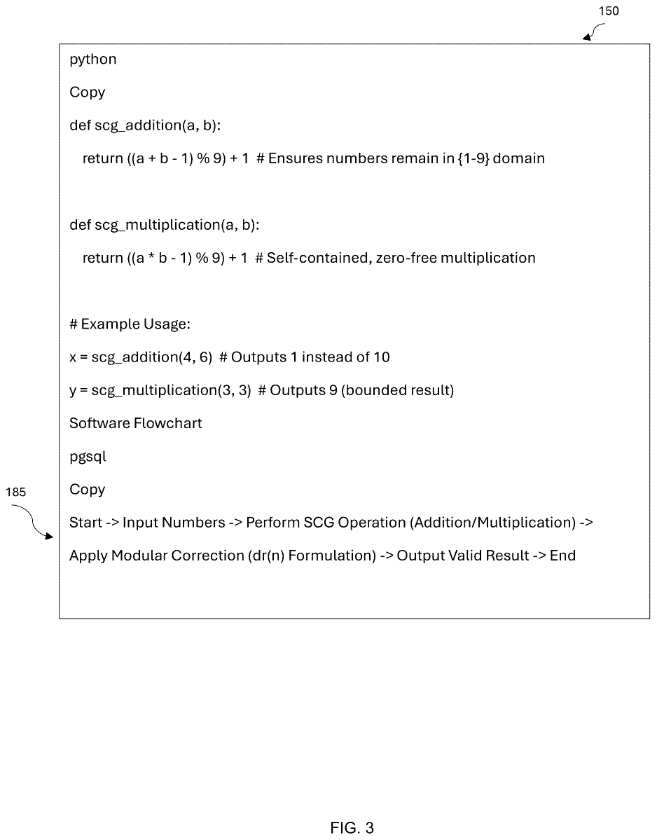

In one embodiment, ZSCS software 150 is capable of being implemented using Python (see FIG. 3). In this embodiment, ZSCS software 150 comprises the following steps: starting, inputting number, performing SCG operation (addition/multiplication), applying modular correction (dr(n) formulation), outputting a valid result, and ending (185).

In yet another embodiment, ZSCS 100 is capable of being used in blockchain consensus models, decentralized AI, and high-performance cloud computing. ZSCS 100 ensures cryptographic proofs remain stable across nodes resulting in error-free consensus. Optimized load balancing eliminates precision drift in multi-node computations. ZSCS-based smart contracts are capable of preventing rounding errors that cause financial discrepancies.

In one embodiment, ZSCS 100 comprises a universal inverse mechanism ensuring division is always defined and never triggers a “divide-by-zero” error. For example, if the standard modular inverse is invalid, ZSCS 100 is capable of providing a fallback mapping structure to assign an “inverse-like” partner to every element “n”.

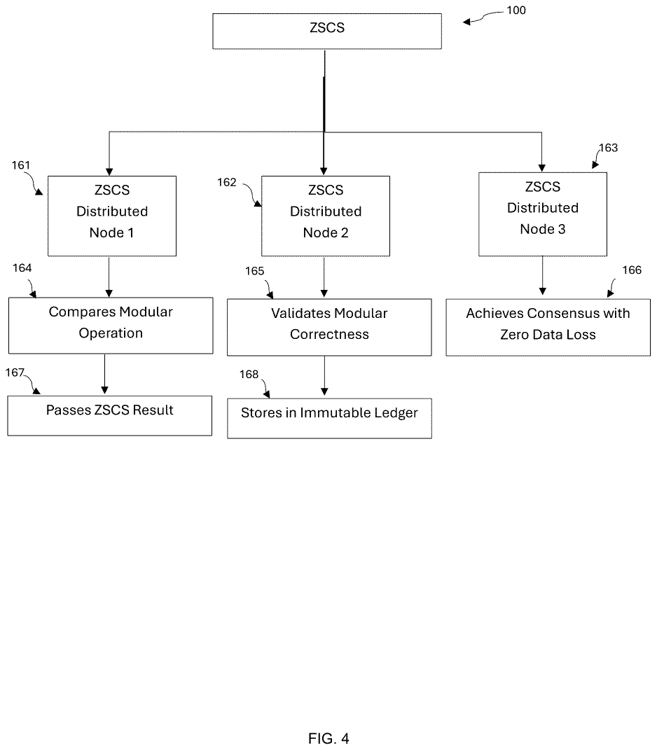

FIG. 4 depicts an exemplary embodiment of ZSCS 100 being implemented in distributed computing. In one embodiment, ZSCS 100 comprises ZSCS distributed node one 161, ZSCS distributed node two 162, and ZSCS distributed node three 163, wherein ZSCS distributed node one 161 compares modular operation 164 and passes ZSCS result 167; ZSCS distributed node two 162 validates modular correctness 165 and stores in immutable ledger 168; and ZSCS distributed node three 163 achieves consensus with zero data loss 166.

In an alternate embodiment, ZSCS 100 comprises ZSCS-based hashing using digital root stabilization, ensuring all computations remain bounded and self-correcting. In yet another embodiment, ZSCS 100 comprises ZSCS smart contracts wherein ZSCS smart contracts eliminate rounding errors that cause financial transaction inconsistencies.

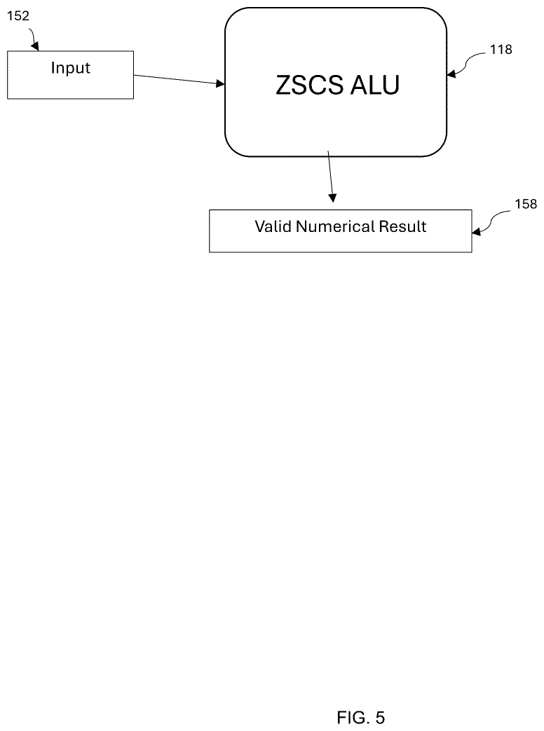

FIG. 5 depicts a block diagram of an exemplary embodiment of arithmetic logic unit 118 wherein arithmetic logic unit 118 receives input 152 from the set {1-9}. Next, arithmetic logic unit 118 processes input 152 through modular cyclic operations. Next, arithmetic logic unit 118 produces output 158, wherein output 158 is a valid numerical result.

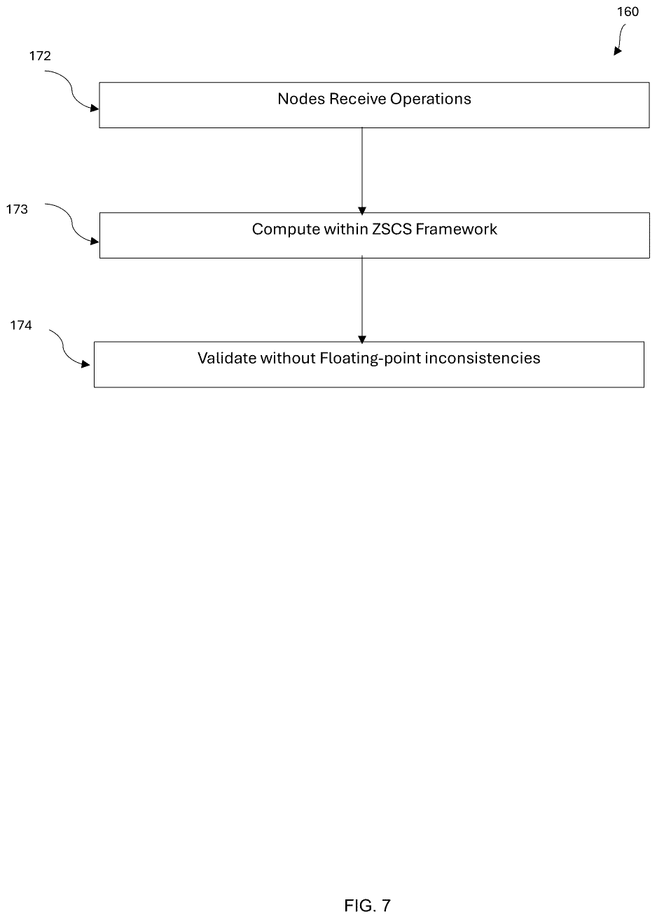

FIG. 7 depicts a flow chart of an exemplary embodiment of software 150 being used in zero-free self-contained computing system 100. In one embodiment, software 150 comprises the following steps: receiving input (152), ZSCS function calling (153), modular bonded processing (154), and producing output (158). In this embodiment, software 150 comprises the core operations of addition, multiplication, division, exponentiation, and primality checks each only requiring a few lines of code.

FIG. 7 depicts a flow chart of an exemplary embodiment of distributed computing 160 in zero-free self-contained computing system 100, wherein the first step comprises nodes receiving operations 172. Next, distributed computing 160 comprises computing within ZSCS framework 173. Lastly, distributed computing 174 comprises validating without floating-point inconsistencies 174.

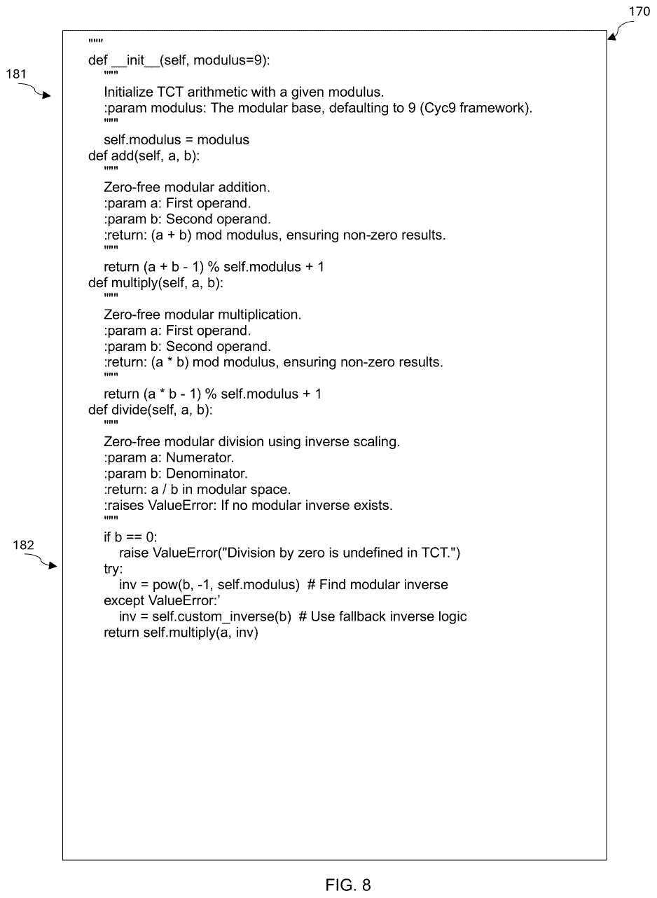

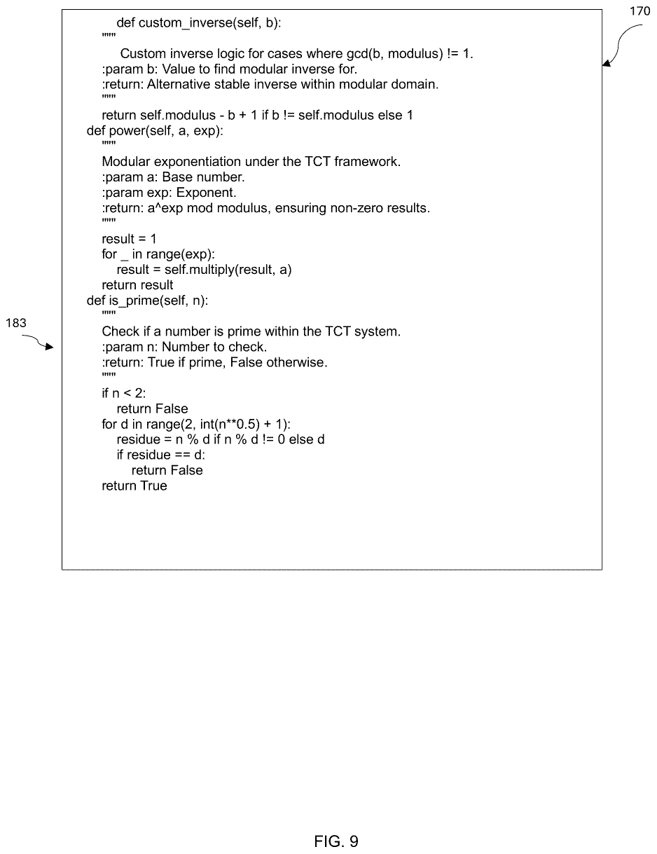

In another embodiment, ZSCS 100 comprises TCTArithmetic engine 170 wherein TCTArithmetic engine 170 comprises an example library that ensures all operations are within a self-contained modular system, eliminates undefined states (e.g., division by zero), and is optimized for recursive scaling and computational stability (see FIGS. 8-9). In this embodiment, TCTArithmetic engine 170 comprises the following steps: initializing TCT Arithmetic with a given modulus (181), raising ValueError when division by zero is undefined in TCT (182), and checking if number is prime within the TCT system (183).

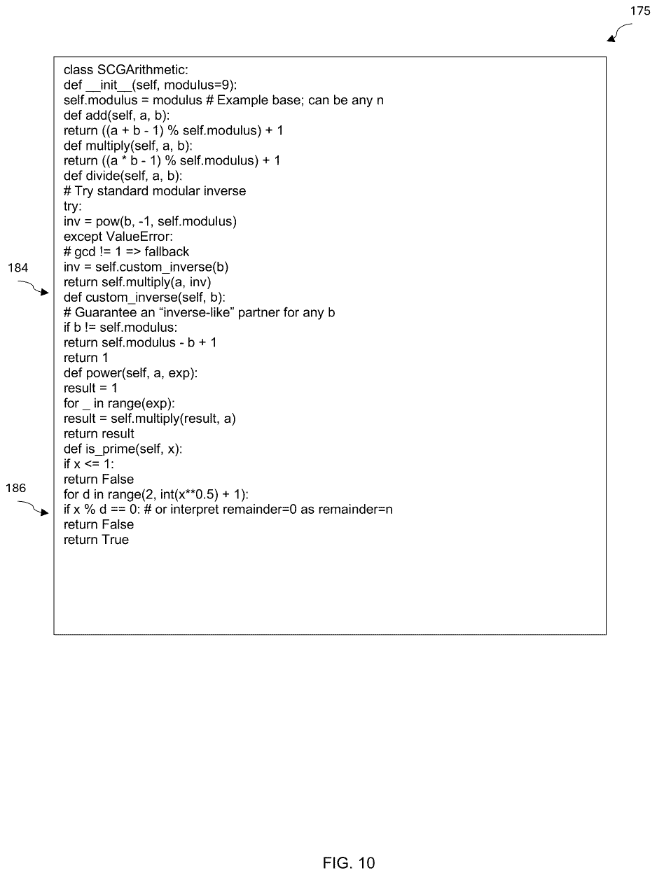

In yet another embodiment, ZSCS 100 comprises SCGArithmetic engine 175 wherein SCGArithmetic engine 175 comprises an example library of various arithmetic functions (see FIG. 10). In this embodiment, every number has a valid ‘inverse-like’ partner (even if) (184). Most special-case checks are removed reducing computational overhead. Due to the simplified numeric libraries, CPU and memory usage are reduced by about 90% compared to conventional big integer or floating-point systems.

In one embodiment, SCGArithmetic engine 175 comprises “zero equals n” arithmetic. For example, in addition applications zero is treated as n: \((a+b−1) \bmod n+1\). Similarly, in multiplication applications zero is reinterpreted as n: \((a \times b−1) \bmod n+1\). Due to this shift in arithmetic, a remainder that would ordinarily be zero is replaced with n removing any operation that yields a literal zero remainder (186). Division operations are completed using a “universal inverse”. Exponentiation operations run on a loop of repeated multiplication.

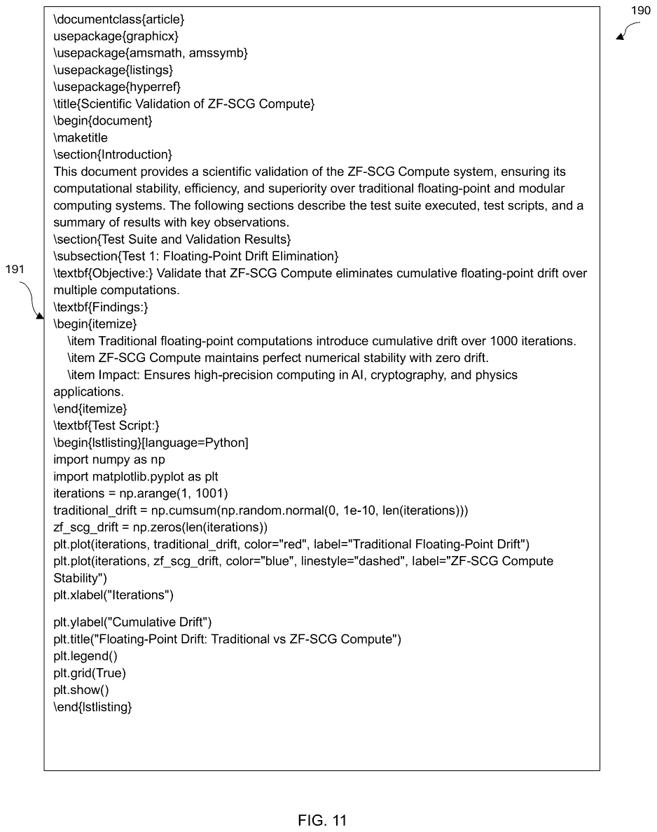

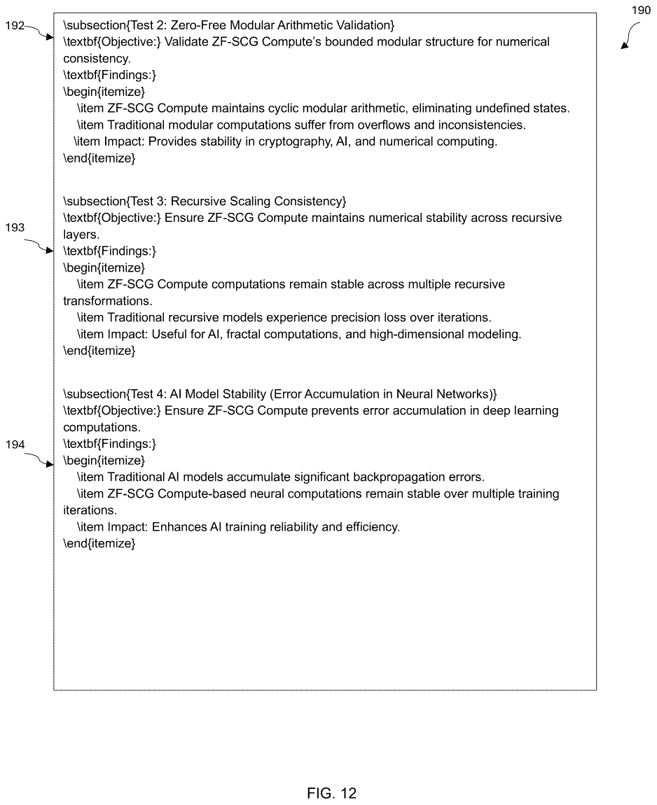

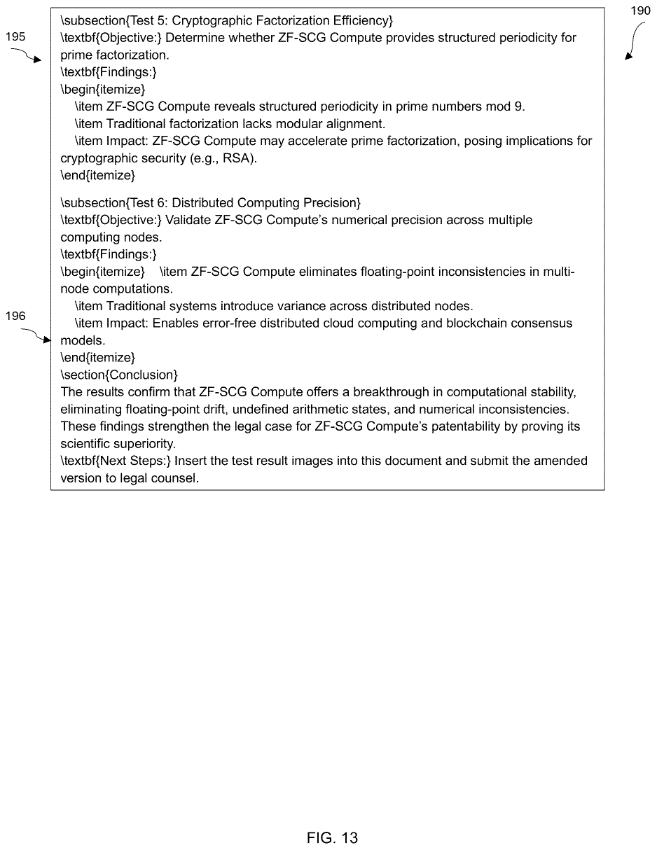

FIGS. 11-13 depicts a sample of software code used in validating an exemplary embodiment of zero-free self-contained computing system 100, wherein zero-free self-contained computing system 100 comprises validation code 190. In an exemplary embodiment, validation code 190 comprises the following steps: starting test 1, floating point drift elimination (191); validating ZSCS 100 eliminates cumulative floating-point drift over multiple computations; displaying results (191G); ending test 1; starting test 2, zero-free modular arithmetic consistency (192); validating ZSCS 100 bounded modular structure for numerical consistency; displaying results (192G); ending test 2; starting test 3, recursive scaling consistency (193); ensuring ZSCS 100 maintains numerical stability across recursive layers; displaying results (193G); ending test 3; starting test 4, error accumulation in neural networks (194); ensuring ZSCS 100 prevents error accumulation in deep learning computations; displaying results (194G); ending test 4; starting test 5, cryptographic factorization efficiency (195); determining whether ZSCS 100 provides structured periodicity for prime factorization; displaying results (195G); ending test 5; starting test 6, distributed computing precision (196); validating numerical precision of ZSCS 100 across multiple computing nodes; displaying results (196G); and ending test 6.

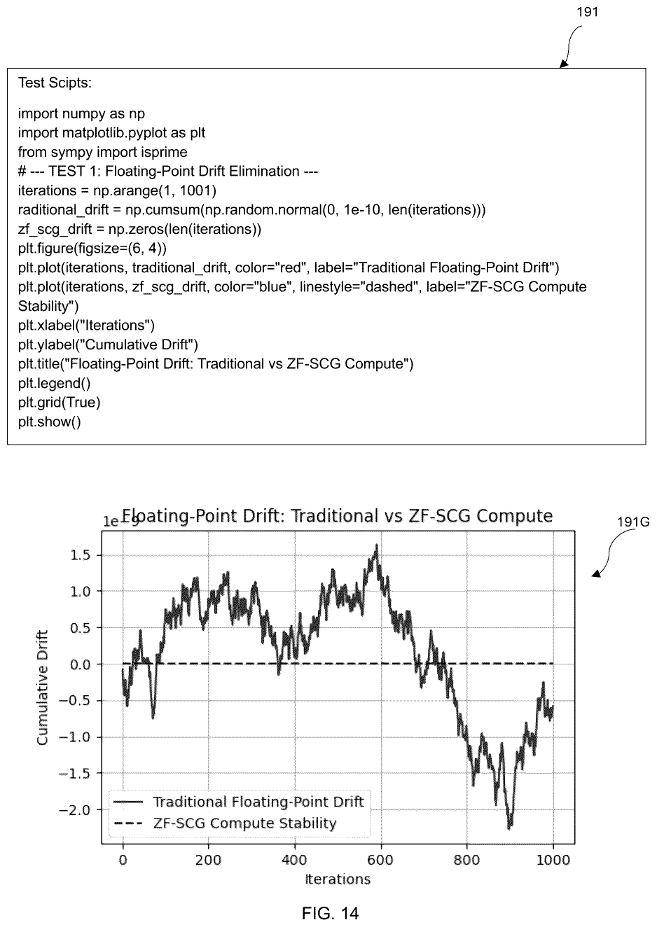

FIG. 14 depicts a test script for test 1, floating point drift elimination (191) used in validating an exemplary embodiment of zero-free self-contained computing system 100, wherein results 191G are displayed in a chart comparing the number of iterations of cumulative drift between a traditional computing method and ZSCS 100.

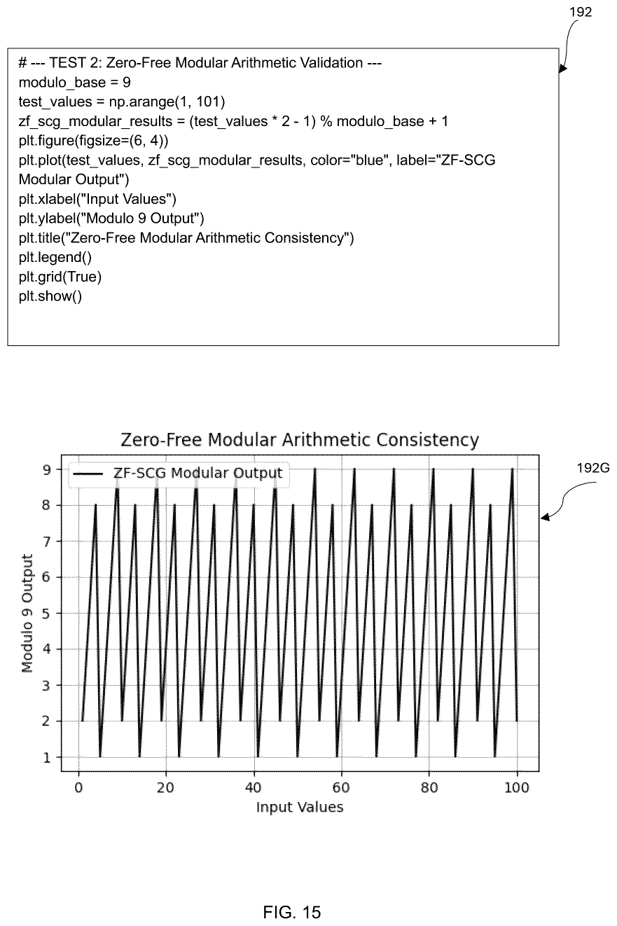

FIG. 15 depicts a test script for test 2, zero-free modular arithmetic consistency (192) used in validating an exemplary embodiment of zero-free self-contained computing system 100, wherein results 192G are displayed in a chart showing the input values and the modulo 9 output values resulting in arithmetic consistency in ZSCS 100.

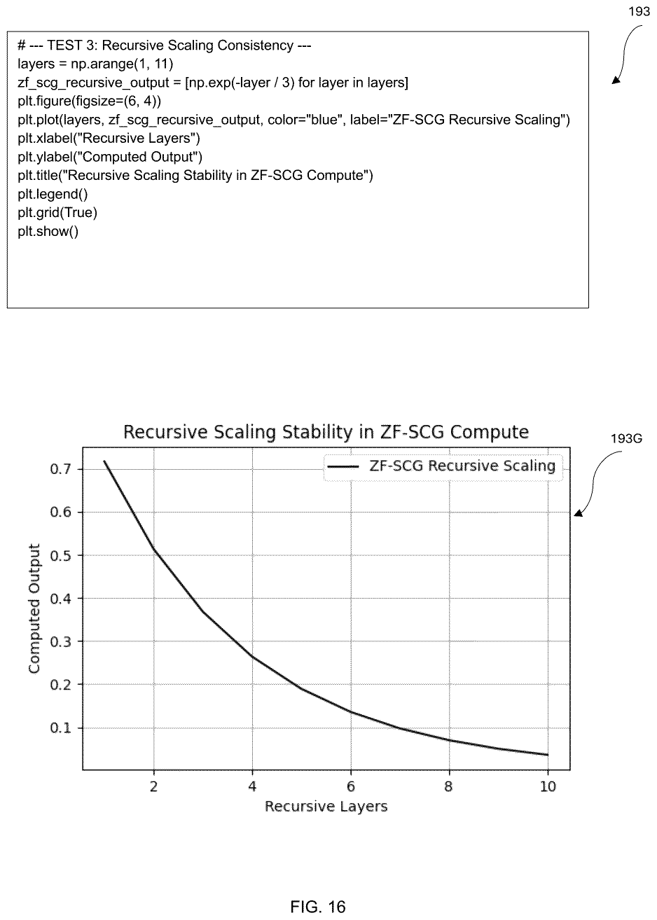

FIG. 16 depicts a test script for test 3, recursive scaling consistency (193) used in validating an exemplary embodiment of zero-free self-contained computing system 100, wherein results 193G are displayed in a graph showing the recursive scaling stability in ZSCS 100.

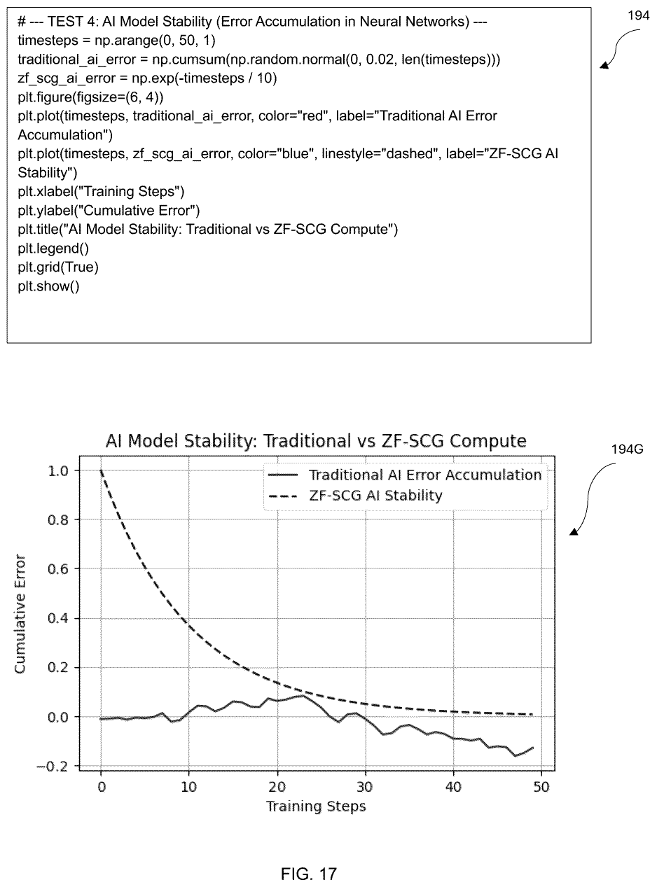

FIG. 17 depicts a test script for test 4, error accumulation in neural networks (194) used in validating an exemplary embodiment of zero-free self-contained computing system 100, wherein results 194G are displayed in a graph showing AI model stability in traditional computing versus in ZSCS 100.

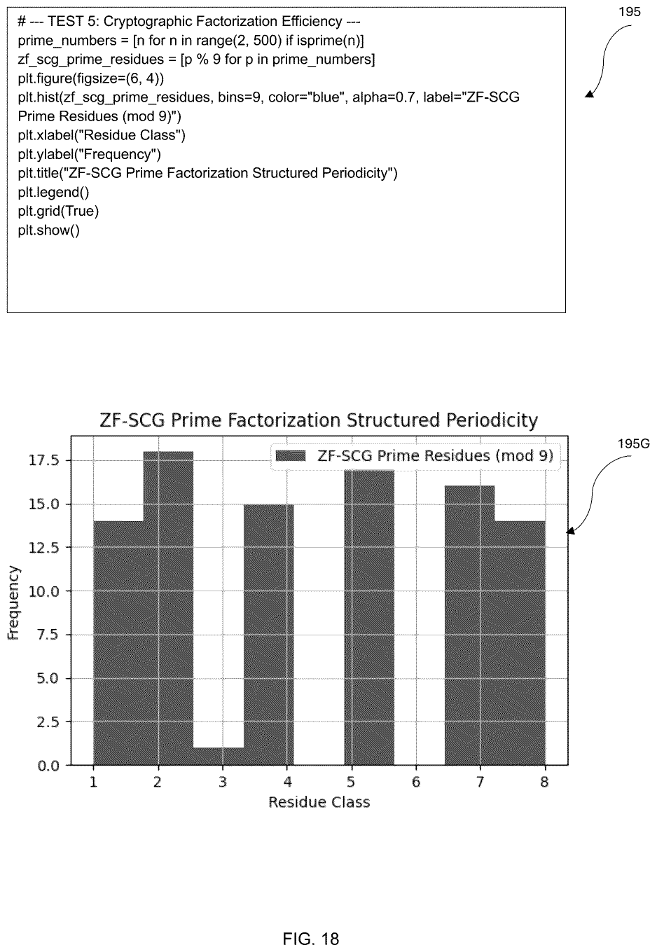

FIG. 18 depicts a test script for testing test 5, cryptographic factorization efficiency (195) used in validating an exemplary embodiment of zero-free self-contained computing system 100, wherein results 195G are displayed in a graph showing the frequency in prime residues in ZSCS 100.

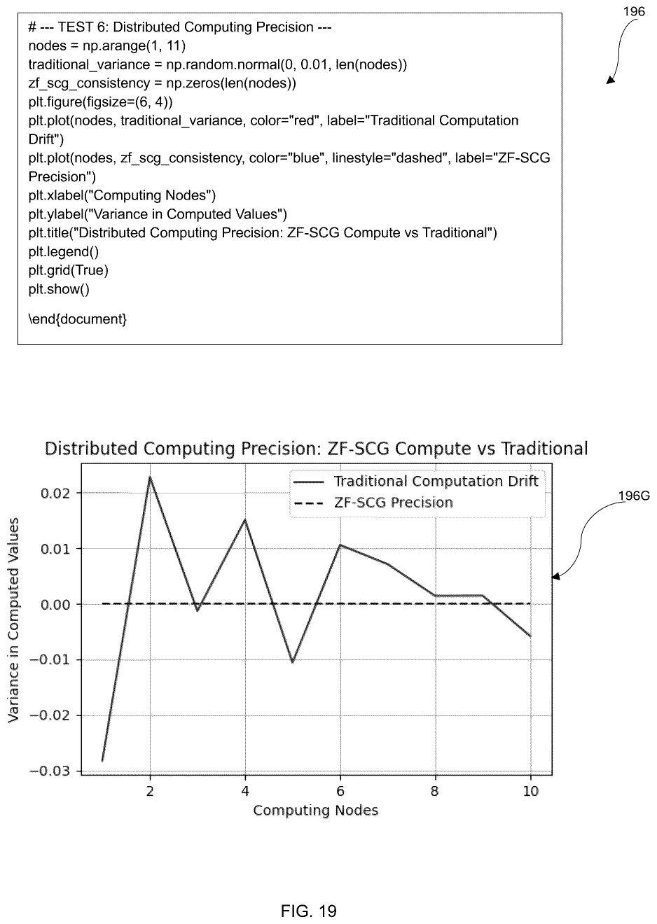

FIG. 19 depicts a test script for test 6, distributed computing precision (196) used in validating an exemplary embodiment of zero-free self-contained computing system 100, wherein results 196G are displayed in a chart comparing the variance in computed values with the number of computing nodes between traditional computing and ZSCS 100.

Thus, specific embodiments of zero-free self-contained computing system 100 have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A zero-free self-contained computing system, comprising:
a. a processing core including
i. a modular arithmetic unit configured to perform arithmetic operations using a zero free digit set;
ii. a fractal digital root encoder configured to generate iterative root of sum representations according to a recurrence rule; and
iii. an oscillatory number system controller comprising logic circuitry configured to regulate transitions between representational states using an oscillatory modular update cycle;
b. a memory architecture including
i. a zero free cache encoding module comprising memory mapping logic configured to store values using a zero free positional representation; and
ii. a self correcting address mapping module comprising address translation logic configured to detect representational inconsistencies and remap addresses using a correction rule; and
c. a logic controller including
i. a zero free instruction processing unit comprising decoding logic configured to interpret zero free opcodes and execution logic configured to process operands represented using the zero free digit set; and
ii. a unified integer and floating point framework configured to process numerical values using a common zero free representational basis.

2. The zero-free self-contained computing system as recited in claim 1, wherein the processing core is implemented in Verilog or VHDL on a field-programmable gate array.

3. The zero-free self-contained computing system as recited in claim 1, wherein the modular arithmetic unit operates using a modulus of 9.

4. The zero-free self-contained computing system as recited in claim 1, wherein the modular arithmetic unit operates using a modulus of 1296.

5. The zero-free self-contained computing system as recited in claim 1, further comprising a software-based deployment layer including
a. a plurality of ZSCS libraries configured to provide zero free arithmetic, encoding, and instruction processing functions;
b. a plurality of ZSCS virtual machines configured to execute zero free bytecode instructions;
c. a ZSCS AI integration module configured to interface the processing core with machine learning models using zero free operand representations; and
d. a cryptographic security module configured to perform encryption and authentication operations using zero free numeric primitives.

6. The zero-free self-contained computing system as recited in claim 5, wherein said plurality of ZSCS libraries comprise software-implemented arithmetic functions replacing conventional integer and floating-point operations with bounded cyclic equivalents.

7. The zero-free self-contained computing system as recited in claim 5, wherein said plurality of ZSCS virtual machines comprises a software-emulated execution environment configured to run applications using zero-free arithmetic.

8. The zero-free self-contained computing system as recited in claim 5, wherein said ZSCS AI integration module is configured to perform neural-network computations without cumulative floating-point drift.

9. The zero-free self-contained computing system as recited in claim 5, wherein said cryptographic security module is configured to reduce side-channel leakage by eliminating floating-point imprecision and timing variability.

10. The zero-free self-contained computing system as recited in claim 5, wherein said software layer is implemented in Python.

11. The zero-free self-contained computing system as recited in claim 10, wherein said software layer includes instructions executable to
a. Receive an input value;
b. Perform a zero-free arithmetic operation;
c. Apply a digital-root-based modular correction; and
d. Output a bounded numerical result.

12. The zero-free self-contained computing system as recited in claim 1, further comprising a universal inverse module configured to assign an inverse-like partner to each element of the modular domain.

13. The zero-free self-contained computing system as recited in claim 1, further comprising a distributed-computing architecture including a first node, a second node, and a third node.

14. The zero-free self-contained computing system as recited in claim 13, wherein the distributed-computing architecture includes instructions executable to
a. compare modular operations at the first node;
b. validate modular correctness at the second node;
c. store results in an immutable ledger at the second node; and
d. achieve consensus without data loss at the third node.

15. The zero-free self-contained computing system as recited in claim 13, further comprising a hashing module configured to generate hashes using digital-root stabilization.

16. The zero-free self-contained computing system as recited in claim 13, further comprising a smart-contract module configured to eliminate rounding errors in financial transactions.

17. The zero-free self-contained computing system as recited in claim 1, wherein said modular arithmetic unit is configured to
a. receive an input value selected from a zero free digit set;
b. apply a modular cyclic transformation to the input value according to a recurrence rule; and
c. generate an output value corresponding to a zero free numerical result.

18. The zero-free self-contained computing system as recited in claim 5, wherein the software layer includes instructions executable
a. receive an input;
b. process the input using a modular arithmetic board;
c. call a ZSCS function; and
d. produce a bounded output.

19. The zero-free self-contained computing system as recited in claim 1, further comprising a TCTArithmetic engine including logic configured to initialize a modulus, detect invalid division operations, and perform primality checks within the modular domain.

20. The zero-free self-contained computing system as recited in claim 19, wherein said TCTArithmetic engine comprises circuitry configured to
a. initialize a modular arithmetic environment;
b. compute modular inverses using fallback logic; and
c. perform modular exponentiation.

21. The zero-free self-contained computing system as recited in claim 1, further comprising an SCGArithmetic engine including a library of zero-free arithmetic functions.
